(19) United States
(12) Patent Application Publication
(10) Pub. No.: US 2020/0062624 A1
(43) Pub. Date: Feb. 27, 2020

(54) HIGH-EFFICIENCY BIO-ELECTROCHEMICAL WASTEWATER TREATMENT SYSTEM FOR COPPER REMOVAL

(71) Applicant: Dalian University of Technology, Dalian City (CN)

(72) Inventors: Lifen LIU, Dalian City (CN); Changfei GAO, Dalian City (CN)

(21) Appl. No.: 16/346,517

(22) PCT Filed: Jun. 20, 2018
(86) PCT No.: PCT/CN2018/091908

§ 371 Date: Apr. 30, 2019

(30) Foreign Application Priority Data
Dec. 22, 2017 (CN) 201711402903.2

(51) Int. Cl. C02F 3/00; C02F 3/34; C02F 3/04

(52) U.S. Cl. CPC C02F 3/005; C02F 2101/20; C02F 3/04; C02F 3/34

(57) ABSTRACT

Treatment of wastewater containing heavy metal ions, and providing an efficient bio-electrochemical copper ion removal system. Based on the technology of microbial fuel cell and membrane bioreactor, using sacrificial aluminum anode and externally supplied power from microbial fuel cell, aluminum micro-electrolysis is realized. Aluminum hydrate ion, produced by micro-electrolysis of aluminum under the action of water molecules, is naturally efficient flocculating agent. The flocculating agent of this system is self-generated without any external reagent addition. The process of flocculation is mild, and the flocculation removal efficiency of copper ion is high. Under the filtration and screening effect of bifunctional conductive membrane, the copper ion in the cathode chamber can be completely removed. The concentration of the copper ion in the effluent of the system can fully meet the national first-level discharge standard, and the effluent can be recycled and reused.

### TECHNICAL FIELD

The invention belongs to the technical field of treatment of wastewater containing heavy metal (copper) ions. Specifically, aluminum sheet, activated carbon and graphite particles are used as the anode of the bio-electrochemical system, while the carbon fiber based conductive membrane containing the catalyst of iron doped manganese dioxide serves as the cathode. The organic wastewater and copper-containing wastewater flow into the anode chamber and the cathode chamber respectively and simultaneously. The organic wastewater functions as the substrate of electromechanical microorganism in the anode chamber during which the organics in wastewater were degraded, and the microorganism transforms the energy into electricity in the same time. In the anode chamber, different potentials of the aluminum sheet and activated carbon make it natural galvanic cells in the anode chamber which could trigger the micro-electrolysis and obtain self-generated electricity. Under the self-generated electric field, aluminum sheets constantly release aluminum ions to achieve electrocoagulation, which not only facilitates the flocculation and precipitation of organic pollutants, but also promotes copper ions removal due to direct combination of the excessive hydrated aluminum ions and copper ions in the cathode. The conductive membrane composited with iron-manganese catalyst, as the cathode and the medium of filtration, can significantly improve the quality of effluent. Furthermore, the copper ions on the surface of cathode can form copper and cuprous oxide through redox reactions to realize its recovery due to the lower reduction potential of copper ions than oxygen molecules. Therefore, this system integrated several processes in simultaneous degradation and purification treatment of the organic wastewater and the copper-containing wastewater to get high quality effluent which can be secondarily utilized. This technology has low operating cost and wide application area.

### BACKGROUND

Microbial fuel cell (MFC) is a newly arising technology that use the electricity generating microorganism to transform bio-energy into electricity. An MFC consists of bio-anode, proton exchanging membrane and bio-cathode. In the anode chamber, an anaerobic environment is provided, and the anaerobic electricity-generating microorganisms degrade organics in wastewater during metabolism and transform biomass energy into electricity synchronously. The generated electrons are transferred from the anode to the cathode. In the cathode chamber, aerobic microorganisms further treat the anode effluent in oxygen-enriched environment to continuously remove the organic matters in wastewater. The bi-functional conductive membrane serves as the cathode of the fuel cell and the filter medium of the membrane bioreactor, to achieve negative pressure gradient to filtrate the effluent in the cathode chamber/membrane bioreactor.

Micro-electrolysis, taking advantage of different potential of aluminum and carbon, consists in the natural galvanic battery between aluminum (micro-anode) and carbon particles (micro-cathode). In the process of micro-electrolysis, aluminum is corroded to constantly release aluminum ions which are transformed into hydrated ions or complexes by water molecules and serve as a kind of natural flocculants to remove the pollutants in wastewater via various processes such as adsorption, flocculation and precipitation. Thus the electro-flocculation purification of wastewater is achieved, and heavy metal (copper, zinc and chromium et al.) ions can be removed by flocculation and precipitation after their reactions with hydrated aluminum ions.

Membrane bioreactor (MBR) is a mainstream process of wastewater treatment and its operating mechanism includes the aerobic treatment of the microorganisms and the filtration of the membrane media. On the one hand, the membrane bioreactor can provide sufficient oxygen for aerobic microorganism by aeration, and under the oxygen-enriched environment, aerobic microorganisms can biodegrade pollutants through metabolism by taking organic matters in water as the carbon source. On the other hand, the degraded wastewater is further purified in the reactor through the filter membrane with the molecular-sieving function so as to achieve the high quality effluent.

This invention is to use micro-electrolysis/electro-flocculation process to in situ prepare natural aluminum flocculating agent. The influents of the anode chamber and the cathode chamber are organic wastewater and copper-containing wastewater respectively. The organic wastewater can support the metabolic process of electricity-producing microorganism to realize the anaerobic wastewater treatment in the anode chamber and accelerate the electrolytic process of sacrificed aluminum anode via the self-biased electric field to continuously provide aluminum ions. The effluent of the anode is mixed with the copper-containing wastewater after go through the overflow tank and contact with the oxidizing bed via the aeration in the hollow tower. The naturally dissolved oxygen, fully mixed copper ions and the flocculating agent accelerates the reaction and greatly promotes the removal of copper ions. The double inflows into the two chambers of the system allow the support of organic waste water to the treatment of copper-containing wastewater, and can synchronously realize the efficient purification of these two kinds of wastewater. This system has high quality effluent, and exhibits remarkable adaptability to high-load wastewater and copper-containing heavy metal wastewater, which shows great potential of application and notable practicability.

### SUMMARY

This invention aims to provide a high-efficiency bio-electrochemical wastewater treatment system for copper removing, which can solve the problems of difficult treatment and low quality effluent of copper containing wastewater. The low operation cost of the overall process and no chemical agent requiring make it a low-cost and high-efficient treatment process.

The technical proposal of the invention:

An efficient bio-electrochemical copper removal wastewater treatment system is designed as follows:

In the bio-electrochemical system, the pump, tuning the flow rate of raw organic wastewater, is connected to the anode chamber and the water inlet at the bottom; aluminum anode is inserted into the filler layer of anode chamber and used as the sacrificed anode. The filler layer consists of activated carbon and graphite particles whose volume ratio is 1:1 and filling rate is 100%. The anode is connected to the data acquisition system via a wire from its top as well as the reference electrode which is inserted into the upside of the anode chamber. The mixed filler of activated carbon and graphite particles which is inoculated with electricity-generating microorganism in advance is used as a bio-anode together with aluminum anode in the anode chamber. The inoculation is realized by inletting low flow rate organic wastewater to support the biofilm formation of electricity-generating microorganism. Air exhaust holes are reserved at the top of the anode chamber to naturally discharge the carbon dioxide and other gases generated during the anaerobic process. The anode chamber is connected to the overflow tank with drip filter holes in the bottom. Oxygen dissolution and gas-liquid exchange process occur and are realized after the water outlet flow from the anode chamber to the overflow tank.

The tank of copper containing wastewater is connected with the Cu-wastewater pump, Cu-wastewater flow rate is tuned through this pump; Its outlet is set at the bottom of the overflow tank, above the top of the surface aeration/contact oxidation bed;

After trickling filtration, the organic wastewater is mixed directly with the copper-bearing wastewater in the top of the surface aeration contact oxidation bed; the surface aeration/contact oxidation bed is filled with volcanic rock filter material with a filling rate of 100%; the outer sealing plate of the surface aeration/contact oxidation bed is an arranged multi-channel porous structure, and the air enters through the channel pores into the surface aeration/contact oxidation bed to meet the oxygen demand of microorganisms in the bed; a plate for effluent is set at the bottom of the surface aeration/contact oxidation bed, and the mixture of organic wastewater and copper wastewater after tertiary advanced treatment in the bed overflows to the cathode chamber.

This high efficient copper removal bio-electrochemical water treatment system replaces proton exchange membrane with multi-media chamber which is filled with a mixture of manganese sand and activated carbon particles at a volume ratio of 1:1 and a filling rate of 100%. The multi-media chamber connecting the cathode and the anode is sealed by a non-woven fabric to prevent outflow of the filler, and both the side plates of anode and cathode chamber are set with holes channels for proton transfer flow.

A supplementary aeration system is preset at the bottom of the cathode chamber. The aerator is set at double rows, the cathode chamber serves as membrane bioreactor synchronously. The catalytic conductive membrane electrode with iron/manganese/oxygen acts as the cathode and filter in membrane bioreactor. The membrane module discharges water upon suction and vacuum pressure through a water pump and the flow rate is controlled by a flow meter.

The anode and cathode of the system are connected with external resistance and linked to the data acquisition system.

Advantages of this invention: Based on microbial fuel cell and membrane bioreactor technology, the system realizes micro-electrolysis of aluminum by using a sacrificial aluminum anode and a microbial fuel cell to provide external power source. The electrolytic dissolved aluminum ions generate aluminum hydrated ions under the action of water molecules. As a natural and efficient flocculating agent, the flocculation purification of organic waste water can be realized by aluminum hydrated ions, and it is also a key factor for the removal of copper ion. This system can generate flocculating agent without any external addition, and the flocculation reaction process is mild and efficient to copper removal. Under the filtration and screening action of the bifunctional conductive membrane, the copper ions can be completely removed in the cathode chamber. The concentration of copper ions in the effluent of the system meets national first-level emission standards and can be recycled and reused.

### DESCRIPTION OF FIGURES

FIG. 1 shows the removal performance of copper ions

In the figure: the abscissa indicates time and the unit is d. The ordinate indicates the concentration and pollutant removal efficiency of influent and effluent using the unit of mg/L and %. The dot and the diamond block respectively indicate the concentration of copper ion in the influent and effluent, and the square indicates the removal rate.

FIG. 2 is a COD removal performance diagram.

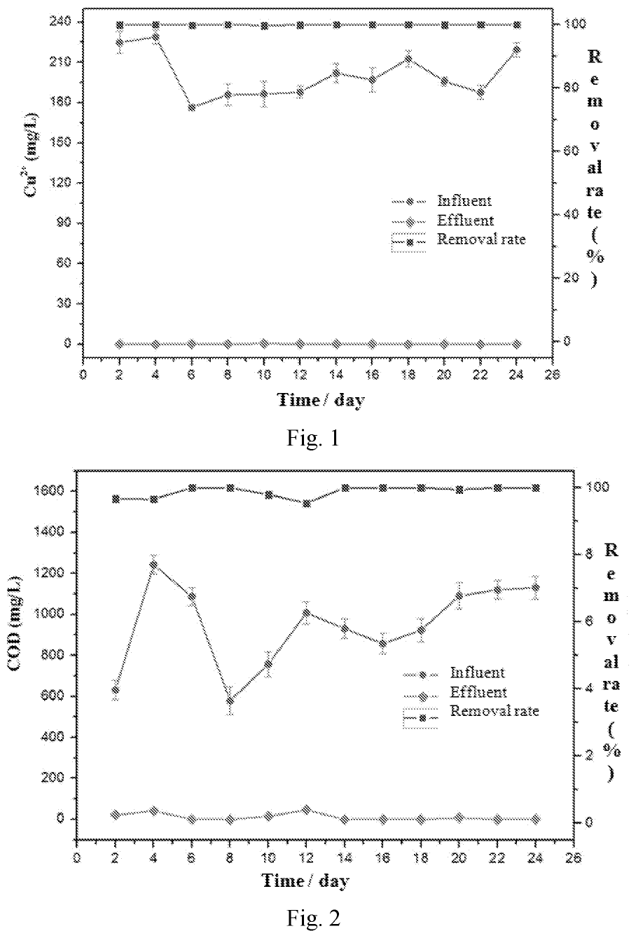

In the figure: the abscissa indicates time and the unit is d. The ordinate indicates the concentration and pollutant removal efficiency of influent and effluent using the unit of mg/L and %. The dot and the diamond block respectively indicate the concentration of COD in the influent and effluent, and the square indicates the removal rate.

### SPECIFIC IMPLEMENTATION METHODS

Specific implementation method of the present invention is further described as below combining with drawings and the technical solution.

The anode chamber of the bio-electrochemical water treatment system: the size of the anode chamber is 0.1 m×0.1 m×0.5 m, the inlet is reserved at the bottom of the anode chamber, the U-shaped tube of the inlet is above the top of the chamber, and the inlet pipe is connected with the feed water pump. The influent flow rate is set as 8 L/D. The anode chamber is filled with a mixed fillers (activated carbon and graphite particles with a particle diameter of 3-5 mm and a mixed volume ratio of 1:1), and the volumetric filling rate is 100%. A calomel reference electrode is inserted at the top of the chamber, and the electrode is connected to a data acquisition system. An aluminum can cut without bottom is inserted into the fillers on the top center of the chamber. The top of the can is cut and connected with the data acquisition system through a copper wire. A vent hole is reserved at the top of the chamber. The upper part of the anode chamber is connected with the overflow tank, fabricated with 10 adjustable inner tooth pipe outlets in the bottom of tank to adjust effluent flow rate.

Vacant aeration contact oxidation bed: the size of the oxidation bed is 0.1 m×0.1 m×0.3 m, the oxidation bed is filled with volcanic rock filler and the particle size is 15-30 mm, the volumetric filling ratio is 90%; the top of the oxidation bed is externally led to the copper-containing wastewater inlet pipe. The influent flow rate of the copper-containing wastewater was set to 8 L/D. The organic wastewater under the drip filtration of the overflow tank is mixed with the copper-containing wastewater at the top of the oxidation bed and enters the oxidation bed. The air side of the oxidation bed is set to face a Φ12 (mm) porous sealing plate to provide an oxygen transmission channel.

Multi-medium chamber: the multi-medium chamber is filled with manganese sand and activated carbon (particle size is 0.5-1 mm), and the mixed volume ratio is 1:1. The multi-medium chamber is connected with the anode chamber and the cathode chamber, and a 70 mm×30 mm proton transfer channel is reserved at the bottom of the sealing plate, and the passage port is sealed with a non-woven inner thread hole. The top of the sealing plate connected to the multi-media chamber and the cathode chamber is reserved for a channel of 80 mm×10 mm, and the outlet from the vacant aeration/contact oxidation bed flows into the cathode chamber of the system through the channel.

Cathode chamber/membrane bioreactor of bio-electrochemical water treatment system: the chamber size is 0.1 m×0.1 m×0.3 m, and the cathode chamber is used as a membrane bioreactor at the same time. The supplementary aeration is reserved at the bottom of the chamber and set in double rows. The aeration flow rate is controlled by a gas flow meter to keep the dissolved oxygen concentration in the chamber higher than 4.8 mg/L. The iron-manganese catalytic conductive membrane serves as both the system cathode and the membrane bioreactor filter medium, and is fabricated as a flat membrane module. The outlet of the module is connected to a pump to keep the flow rate at 16 L/D. The outlet pump can also be used as a membrane module's backwashing pump. An overflow port is reserved at the top of the chamber, and a sludge outlet is reserved at the bottom.

Performance test: after inoculating the electricity-generating microorganisms in the anode chamber of the bio-electrochemical water treatment system, performance test was carried out 10 days after the biofilm was attached. The experimental results show that the organic wastewater and the copper-containing wastewater can be simultaneously treated/purified in the invented system, and the copper ion concentration and chemical oxygen demand index of the effluent meet the national first-level discharge standard, and the effluent can be recycled as reclaimed water.

1. A high-efficiency bio-electrochemical wastewater treatment system for copper removal, wherein the design steps are as follows:
in the high-efficiency bio-electrochemical wastewater treatment system for copper removal, pump tunes the flow rate of raw organic wastewater, and is connected to the water inlet at the bottom of the anode chamber; where an aluminum anode is inserted into the filler layer of anode chamber and used as the sacrificed anode; the filler layer consists of activated carbon and graphite particles with volume ratio of 1:1 and volumetric filling rate is 100%; the anode is connected to the data acquisition system via a wire from its top as well as the reference electrode which is inserted into the upside of the anode chamber; the mixed filler of activated carbon and graphite particles which is inoculated with electricity-generating microorganism in advance is used as a bio-anode together with aluminum anode in the anode chamber; the inoculation is realized by inletting low flow rate organic wastewater to support the biofilm formation of electricity-generating microorganism; air exhaust holes are reserved at the top of the anode chamber to naturally discharge the carbon dioxide generated during the anaerobic process; the anode chamber is connected to the overflow tank with drip filter holes in the bottom; oxygen dissolution and gas-liquid exchange process occur and are realized after the water flow from the outlet of anode chamber to the overflow tank;
after trickling filtration, the organic wastewater is mixed directly with the copper ion containing wastewater in the top of the surface aeration/contact oxidation bed; the surface aeration/contact oxidation bed is filled with volcanic rock filter material with a filling rate of 100%; the outer sealing plate of the surface aeration/contact oxidation bed is arranged with multi-channel pores, and the air enters through the channel pores into the surface aeration/contact oxidation bed to meet the oxygen demand of microorganisms in the bed; a plate for effluent is set at the bottom of the surface aeration/contact oxidation bed, and the mixture of organic wastewater and copper-containing wastewater after tertiary advanced treatment in the bed overflows to the cathode chamber;
in this highly efficient copper removal bio-electrochemical water treatment system proton exchange membrane is replaced with multi-media chamber that is filled with a mixture of manganese sand and activated carbon particles at a volume ratio of 1:1 and a filling rate of 100%; the multi-media chamber connecting the cathode and the anode is sealed by a non-woven fabric to prevent outflow of the fillers, and both side plates of anode and cathode chamber were set with hole channels open for proton transfer flow;
a supplementary aeration system is preset at the bottom of the cathode chamber; the aerator is set at double rows, the cathode chamber serves as membrane bioreactor synchronously; the catalytic conductive membrane electrode with iron/manganese/oxygen acts as the cathode and filter in membrane bioreactor; the electrode membrane module discharges water by the negative pressure generated by a water pump upon vacuum suction and the flow rate of is controlled by a flow meter;
the anode and cathode of the system are connected with external resistance and linked to the data acquisition system.
